(19) United States
(12) Patent Application Publication
(10) Pub. No.: US 2023/0297641 A1
(43) Pub. Date: Sep. 21, 2023

(54) Data Consistency Check Method and System based on ICC

(71) Applicant: INSPUR SUZHOU INTELLIGENT TECHNOLOGY CO., LTD., Jiangsu (CN)

(72) Inventor: Fang ZHANG, Jiangsu (CN)

(21) Appl. No.: 18/013,812

(22) PCT Filed: Feb. 19, 2021
(86) PCT No.: PCT/CN2021/076849

§ 371 Date: Dec. 29, 2022

(30) Foreign Application Priority Data
Jul. 30, 2020 (CN) 202010750194.2

(51) Int. Cl. G06F 17/15; G06F 16/23; G06F 18/23213; G06F 17/16; G06F 17/18

(52) U.S. Cl. CPC G06F 17/153; G06F 16/2365; G06F 18/23213; G06F 17/16; G06F 17/18

(57) ABSTRACT

Provided are a data consistency check method and system based on an ICC. Unlike ordinary data segmentation, a data segmentation algorithm combining K-means clustering, a complete basis and a PCA dimensionality reduction algorithm is provided in the present disclosure, representative subdata can be extracted under the condition of a large data volume or distributed storage, and then the ICC of the subdata is calculated to perform a rapid data consistency check. Data security in data backup and recovery processes may be effectively guaranteed, data consistency check may be performed under the conditions of internal memory data persistence, data recovery of a disk array device during system crash and accidental outage, etc., unawareness of data losses occurring in a data persistence or recovery process may be avoided, and data security and integrity may be effectively guaranteed.

### CROSS REFERENCE

The present disclosure is a National Stage Filing of the PCT International Application No. PCT/CN2021/076849 filed on Jan. 19, 2021, which claims the benefit of priority of Chinese patent application No. 202010750194.2, entitled “DATA CONSISTENCY CHECK METHOD AND SYSTEM BASED ON ICC”, filed to China National Intellectual Property Administration on Jul. 30, 2020, the entire contents of which are incorporated herein by reference.

### TECHNICAL FIELD

The present disclosure relates to the technical field of software development, in particular to a data consistency check method and system based on an Intraclass Correlation Coefficient (ICC).

### BACKGROUND

Data play an important role in the information era while data security is of primary importance, and thus data backup and recovery are particularly important. For example, during data backup, a system cannot monitor data changes in real time, consequently, the situation of untimely data synchronization will happen. In order to address this problem, data consistency check needs to be performed, and synchronous processing is performed when data are inconsistent. For another example, the data consistency check is needed under cases such as internal memory data persistence demands and data recovery of a disk array device prior to system crash and accidental outage, etc., thereby avoiding unawareness of data losses occurring in a data persistence or recovery process. It can be seen that data consistency check is very widely applied.

There are many consistency check methods at present, but most of the consistency check methods compare all data one by one or compare segmented data, which is unpractical under the condition of a large data volume or distributed data storage, and greatly consumes time and space.

### SUMMARY

A data consistency check method and system based on an ICC are provided, which may solve the problems that time and space are greatly consumed during one-by-one data comparison in the related art, thereby realizing a rapid data consistency check and effectively guaranteeing data security in data backup and recovery processes.

A data consistency check method based on an ICC is provided, which includes:
synchronously performing K-means clustering on source data X and backup data or recovery data Y, and determining respective class numbers and clustering center points;
determining whether the class numbers are the same and the clustering center points are the same, in a case where the class numbers are not the same and/or the clustering center points are not the same, returning a result of inconsistency, and in a case where the class numbers are the same and the clustering center points are the same, continuing to perform data comparison;
calculating a dimension N of classification results, and selecting a support vector or a complete basis, wherein any source data and any backup data or recovery data are able to be linearly represented by a support vector or a complete basis; and
calculating an ICC of each subblock, and in a case where the ICC is equal to 1, confirming data consistency and determining that data consistency check is completed.

In some exemplary implementations, the class numbers and the clustering center points are determined according to following formulas:

$${x}_{s s e} = {\sum }_{k = 1}^{K} {\sum }_{x ∈ {X}_{k}} {\vert x - {m}_{k} \vert}^{2}$$

$${y}_{s s e} = {\sum }_{k = 1}^{K} {\sum }_{y ∈ {Y}_{k}} {\vert y - {m}_{k} \vert}^{2}$$

When xₛₛₑ and yₛₛₑ are minimum, K is the class number, and mₖ is the clustering center point.

In some exemplary implementations, a dimension of the support vector or the complete basis is subjected to dimensionality reduction processing through a Principal Component Analysis (PCA) dimensionality reduction method, which includes:
calculating a covariance matrix C=E[(X−E(X))(X−E(X))^{T}] of n-dimension vectors {x₁, x₂, x₃, . . . xₖ}; and
calculating eigenvalues and eigenvectors of the covariance matrix, arranging the eigenvectors from top to bottom in line according to the eigenvalues, forming a matrix P by front q lines, and determining P×X as data subjected to dimensionality reduction to a q-dimension.

In some exemplary implementations, a computational formula of the ICC is as below:

$${ICC}_{j} = \frac{{\sum }_{i = 1}^{n} ( {x}_{ji} - \overline{xy} ) ( {y}_{ji} - \overline{xy} )}{( n - 1 ) {{s}_{xy}}^{2}}$$

wherein j=1, 2, 3 . . . q, which represents a subscript of the subblock; and
xⱼᵢ and yⱼᵢ are elements in a jth subblock, x̅y̅ is a unite average of the jth subblock, and S_{xy}² is a unite variance of the jth subblock.

A data consistency check system based on an ICC is also provided, which includes:
a classification module, configured to synchronously perform K-means clustering on source data X and backup data or recovery data Y and determine respective class numbers and clustering center points;
a preliminary comparison module, configured to determine whether the class numbers are the same and the clustering center points are the same, wherein in a case where the class numbers are not the same and/or the clustering center points are not the same, a result of inconsistency is returned, and in a case where the class numbers are the same and the clustering center points are the same, continue to perform data comparison;
a complete basis selecting module, configured to calculate a dimension N of classification results, and select a support vector or a complete basis, wherein any source data and any backup data or recovery data are able to be linearly represented by a support vector or a complete basis; and
a correlation coefficient calculating module, configured to calculate an ICC of each subblock, wherein data consistency is confirmed and data consistency check is completed in a case where the ICC is equal to 1.

In some exemplary implementations, the class numbers and the clustering center points are determined according to following formulas:

$${x}_{s s e} = {\sum }_{k = 1}^{K} {\sum }_{x ∈ {X}_{k}} {\vert x - {m}_{k} \vert}^{2}$$

$${y}_{s s e} = {\sum }_{k = 1}^{K} {\sum }_{y ∈ {Y}_{k}} {\vert y - {m}_{k} \vert}^{2}$$

When xₛₛₑ and yₛₛₑ are minimum, K is the class number, and mₖ is the clustering center point.

In some exemplary implementations, a dimension of the support vector or the complete basis is subjected to dimensionality reduction processing through a PCA dimensionality reduction method, which includes:
calculating a covariance matrix C=E[(X−E(X))(X−E(X))^{T}] of n-dimension vectors {x₁, x₂, x₃, . . . xₖ}; and
calculating eigenvalues and eigenvectors of the covariance matrix, arranging the eigenvectors from top to bottom in line according to the eigenvalues, forming a matrix P by front q lines, and determining P×X as data subjected to dimensionality reduction to a q-dimension.

In some exemplary implementations, a computational formula of the ICC is as below:

$${ICC}_{j} = \frac{{\sum }_{i = 1}^{n} ( {x}_{ji} - \overline{xy} ) ( {y}_{ji} - \overline{xy} )}{( n - 1 ) {{s}_{xy}}^{2}}$$

wherein j=1, 2, 3 . . . q, which represents a subscript of the subblock; and
xⱼᵢ and yⱼᵢ are elements in a jth subblock, x̅y̅ is a unite average of the jth subblock, and S_{xy}² is a unite variance of the jth subblock.

A data consistency check device based on an ICC is provided, which includes:
a memory configured to store computer programs; and
a processor configured to execute the computer programs so as to implement the data consistency check method based on the ICC.

A readable storage medium is provided, which is configured to store computer programs executed by a processor so as to implement the data consistency check method based on the ICC.

Effects provided in the Summary are merely effects of the embodiments instead of all effects of the present disclosure, and one of above technical solutions has following advantages or beneficial effects.

Compared with the related art, the present disclosure is not limited to ordinary data segmentation and provides a data segmentation algorithm combining K-means clustering, a complete basis and a PCA dimensionality reduction algorithm, can extract representative subdata under the condition of a large data volume or distributed storage, and then calculate the ICC of the subdata to perform a rapid data consistency check. The solution may perform rapid data consistency check under the condition of a large data volume or distributed storage, may effectively guarantee data security in data backup and recovery processes, may perform data consistency check under the conditions of internal memory data persistence, data recovery of a disk array device during system crash and accidental outage, etc., may avoid unawareness of data losses occurring in a data persistence or recovery process, and may effectively guarantee data security and integrity.

### BRIEF DESCRIPTION OF THE DRAWINGS

FIG. 1 is a flowchart of data consistency check based on an ICC according to the embodiments of the present disclosure; and

FIG. 2 is a block diagram of a data consistency check system based on an ICC according to the embodiments of the present disclosure.

### DETAILED DESCRIPTION

To clearly introduce technical features of solutions, the present disclosure is elaborated according to exemplary implementations and drawings thereof. The following disclosure provides many different embodiments or examples to implement different structures of the present disclosure. To simplify the disclosure, components and settings of the specific examples are described below. In addition, the embodiments of the present disclosure may repeat reference numbers and/or letters in different examples. The repetition aims for simplification and clearness, but not for indicating relationships between the discussed embodiments and/or settings. It needs to be noticed that components shown in the drawings may be not drawn to scale. The embodiments of the present disclosure omit descriptions about commonly-known assemblies, and processing techniques and technologies so as to avoid unnecessary limitations on the present disclosure.

A data consistency check method and system based on an ICC according to the embodiments of the present disclosure are described in detail by combining the drawings.

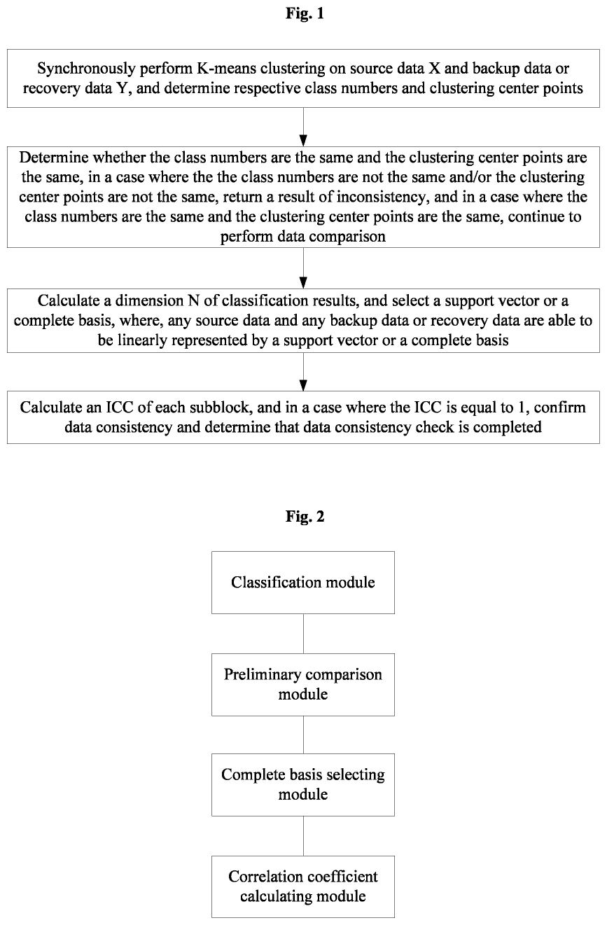

As shown in FIG. 1, the embodiments of the present disclosure provide a data consistency check method based on an ICC, which includes:
synchronously performing K-means clustering on source data X and backup data or recovery data Y, and determining respective class numbers and clustering center points;
determining whether the class numbers are the same and the clustering center points are the same, in a case where the class numbers are not the same and/or the clustering center points are not the same, returning a result of inconsistency, and in a case where the class numbers are the same and the clustering center points are the same, continuing to perform data comparison;
calculating a dimension N of classification results, and selecting a support vector or a complete basis, wherein any source data and any backup data or recovery data are able to be linearly represented by a support vector or a complete basis; and
calculating an ICC of each subblock, and in a case where the ICC is equal to 1, confirming data consistency and determining that data consistency check is completed.

The solution in the embodiments of the present disclosure synchronously performs segmentation on the source data and the backup data or recovery data based on the K-means clustering algorithm, which is not limited to a conventional manner for segmentation according to a data storage initial position. The solution performs segmentation according to a classification algorithm, checks segmentation results, in a case where the segmentation results are the same, calculates a dimension under the condition of a large data volume, selects a representative subblock to serve as the support vector or the complete basis under the data, in a case where a dimension of the support vector or complete basis is high, adopts a PCA dimensionality reduction method to process the dimension of the support vector or complete basis, and performs data consistency check according to the selected subblock based on an ICC check rule.

K-means clustering is synchronously performed on source data X and backup data or recovery data Y, and a sum of squared clustering errors of sample is calculated:

$${x}_{s s e} = {\sum }_{k = 1}^{K} {\sum }_{x ∈ {X}_{k}} {\vert x - {m}_{k} \vert}^{2}$$

$${y}_{s s e} = {\sum }_{k = 1}^{K} {\sum }_{y ∈ {Y}_{k}} {\vert y - {m}_{k} \vert}^{2}$$

xₛₛₑ and yₛₛₑ are respectively made to be minimum, so as to determine an optimal K value and an optimal clustering center point mₖ of the data X and the data Y, and divide the data into K types to obtain {x₁, x₂, x₃, . . . xₖ} and {y₁, y₂, y₃, . . . yₖ}.

Classification results of the source data and the backup data or recovery data are preliminarily compared, whether the K values and the mₖ values for the source data and the backup data or recovery data are respectively the same or not is judged through comparison. In a case where the results are inconsistent, it indicates that the data are inconsistent, judgment does not need to continue, a conclusion about inconsistency is directly returned, and if the results are the same, it indicates that the data may be completely or basically consistent, comparison continues.

A dimension N of the classification results {x₁, x₂, x₃, . . . xₖ} and {y₁, y₂, y₃, . . . yₖ} is calculated, and support vectors or complete bases {x₁, x₂, x₃, . . . xₖ} and {y₁, y₂, y₃, . . . yₙ} under K sets of data are selected so that any x can be linearly represented by {x₁, x₂, x₃, . . . xₙ}, and any y can be linearly represented by {y₁, y₂, y₃, . . . yₙ}.

If a dimension of current obtained base data is still large, a PCA dimensionality reduction method is adopted for processing, which includes:
calculating a covariance matrix C=E[(X−E(X))(X−E(X))^{T}] of n-dimension vectors {x₁, x₂, x₃, . . . xₖ}; and
calculating eigenvalues and eigenvectors of the covariance matrix, arranging the eigenvectors from top to bottom in line according to the eigenvalues, forming a matrix P by front q lines, and determining P×X as data subjected to dimensionality reduction to a q-dimension. Herein, the data are subjected to dimensionality reduction to a low dimension, such as three-dimension: {x₁, x₂, x₃} and {y₁, y₂, y₃}.

ICC of each subblock is calculated according to the dimensionality-reduced subblocks to perform data consistency check. Assuming that there are n data in the subblocks, the ICCs of the subblocks are calculated, for example, q sets of ICCs are calculated based on {x₁, y₁}, {x₂, y₂}, {x₃, y₃} . . . {x_{q}, y_{q}}. An ICC calculating method is as below:

$${ICC}_{j} = \frac{{\sum }_{i = 1}^{n} ( {x}_{ji} - \overline{xy} ) ( {y}_{ji} - \overline{xy} )}{( n - 1 ) {{s}_{xy}}^{2}}$$

wherein j=1, 2, 3 . . . q, which represents a subscript of the subblock,
xⱼᵢ and yⱼᵢ are elements in a jth subblock, x̅y̅ is a unite average of the jth subblock, and S_{xy}² is a unite variance, namely the square of a unite standard error, of the jth subblock.

According to a calculation result, if the ICC is 1, it indicates that the data are consistent, and if not, the data are inconsistent, and the result is returned.

The embodiment of the present disclosure may perform rapid data consistency check under the condition of a large data volume or distributed storage, may effectively guarantee data security in data backup and recovery processes, and may perform data consistency check under the conditions of internal memory data persistence, data recovery of a disk array device during system crash and accidental outage, etc., thereby avoiding unawareness of data losses occurring in a data persistence or recovery process, and thus, data security and integrity may be effectively guaranteed.

As shown in FIG. 2, the embodiments of the present disclosure further provide a data consistency check system based on an ICC, which includes:
a classification module, configured to synchronously perform K-means clustering on source data X and backup data or recovery data Y and determine respective class numbers and clustering center points;
a preliminary comparison module, configured to determine whether the class numbers are the same and the clustering center points are the same, wherein in a case where the class numbers are not the same and/or the clustering center points are not the same, a result of inconsistency is returned, and in a case where the class numbers are the same and the clustering center points are the same, continue to perform data comparison;
a complete basis selecting module, configured to calculate a dimension N of classification results, and select a support vector or a complete basis, wherein any source data and any backup data or recovery data are able to be linearly represented by a support vector or a complete basis; and
correlation coefficient calculating module, configured to calculate an ICC of each subblock, wherein data consistency is confirmed and data consistency check is completed in a case where the ICC is equal to 1.

K-means clustering is synchronously performed on source data X and backup data or recovery data Y, and a sum of squared clustering errors of sample is calculated:

$${x}_{s s e} = {\sum }_{k = 1}^{K} {\sum }_{x ∈ {X}_{k}} {\vert x - {m}_{k} \vert}^{2}$$

$${y}_{s s e} = {\sum }_{k = 1}^{K} {\sum }_{y ∈ {Y}_{k}} {\vert y - {m}_{k} \vert}^{2}$$

xₛₛₑ and yₛₛₑ are respectively made to be minimum, so as to determine an optimal K value and an optimal clustering center point mₖ of the data X and the data Y, and divide the data into K types to obtain {x₁, x₂, x₃, . . . xₖ} and {y₁, y₂, y₃, . . . yₖ}.

Classification results of the source data and the backup data or recovery data are preliminarily compared, whether the K values and the mₖ values for the source data and the backup data or recovery data are respectively the same or not is judged through comparison. In a case where the results are inconsistent, it indicates that the data are inconsistent, judgment does not need to continue, a conclusion about inconsistency is directly returned, and if the results are the same, it indicates that the data may be completely or basically consistent, comparison continues.

A dimension N of the classification results {x₁, x₂, x₃, . . . xₖ} and {y₁, y₂, y₃, . . . yₖ} is calculated, and support vectors or complete bases {x₁, x₂, x₃, . . . xₖ} and {y₁, y₂, y₃, . . . yₙ} under K sets of data are selected so that any x can be linearly represented by {x₁, x₂, x₃, . . . xₙ}, and any y can be linearly represented by {y₁, y₂, y₃, . . . yₙ}.

If a dimension of current obtained base data is still large, a PCA dimensionality reduction method is adopted for processing, which includes:
calculating a covariance matrix C=E[(X−E(X))(X−E(X))^{T}] of n-dimension vectors {x₁, x₂, x₃, . . . xₖ}; and
calculating eigenvalues and eigenvectors of the covariance matrix, arranging the eigenvectors from top to bottom in line according to the eigenvalues, forming a matrix P by front q lines, and determining P×X as data subjected to dimensionality reduction to a q-dimension. Herein, the data are subjected to dimensionality reduction to a low dimension, such as three-dimension: {x₁, x₂, x₃} and {y₁, y₂, y₃}.

ICC of each subblock is calculated according to the dimensionality-reduced subblocks to perform data consistency check. Assuming that there are n data in the subblocks, the ICCs of the subblocks are calculated, for example, q sets of ICCs are calculated based on {x₁, y₁}, {x₂, y₂}, {x₃, y₃} . . . {x_{q}, y_{q}}. An ICC calculating method is as below:

$${ICC}_{j} = \frac{{\sum }_{i = 1}^{n} ( {x}_{ji} - \overline{xy} ) ( {y}_{ji} - \overline{xy} )}{( n - 1 ) {{s}_{xy}}^{2}}$$

wherein j=1, 2, 3 . . . q, which represents a subscript of the subblock; and xⱼᵢ and yⱼᵢ are elements in a jth subblock, x̅y̅ is a unite average of the jth subblock, and S_{xy}² is a unite variance, namely the square of a unite standard error, of the jth subblock.

According to a calculation result, if the ICC is 1, it indicates that the data are consistent, and if not, the data are inconsistent, and the result is returned.

The embodiments of the present disclosure provide a data consistency check device based on an ICC, which includes:
a memory configured to store computer programs; and
a processor configured to execute the computer programs so as to implement the data consistency check method based on the ICC.

The embodiments of the present disclosure further provide a readable storage medium configured to store computer programs executed by a processor so as to implement the data consistency check method based on the ICC.

The above descriptions are merely the exemplary embodiments of the present disclosure, which are not intended to limit the present disclosure. Any modification, equivalent replacement, improvement, etc. made within the spirit and principle of the present disclosure shall fall within the scope of protection of the present disclosure.

1. A data consistency check method based on an Intraclass Correlation Coefficient (ICC), comprising:
synchronously performing K-means clustering on source data X and backup data or recovery data Y, and determining respective class numbers and clustering center points;
determining whether the class numbers are the same and the clustering center points are the same, in a case where the class numbers are not the same and/or the clustering center points are not the same, returning a result of inconsistency, and in a case where the class numbers are the same and the clustering center points are the same, continuing to perform data comparison;
calculating a dimension N of classification results, and selecting a support vector or a complete basis, wherein any source data and any backup data or recovery data are able to be linearly represented by a support vector or a complete basis; and
calculating an ICC of each subblock, and in a case where the ICC is equal to 1, confirming data consistency and determining that data consistency check is completed.

2. The data consistency check method based on the ICC according to claim 1, wherein
the class numbers and the clustering center points are determined according to following formulas:
$${x}_{s s e} = {\sum }_{k = 1}^{K} {\sum }_{x ∈ {X}_{k}} {\vert x - {m}_{k} \vert}^{2}$$
$${y}_{s s e} = {\sum }_{k = 1}^{K} {\sum }_{y ∈ {Y}_{k}} {\vert y - {m}_{k} \vert}^{2}$$
when xₛₛₑ and yₛₛₑ are minimum, K is the class number, and mₖ is the clustering center point.

3. The data consistency check method based on the ICC according to claim 1, wherein a dimension of the support vector or the complete basis is subjected to dimensionality reduction processing through a Principal Component Analysis (PCA) dimensionality reduction method.

4. The data consistency check method based on the ICC according to claim 1, wherein a computational formula of the ICC is as below:
$${ICC}_{j} = \frac{{\sum }_{i = 1}^{n} ( {x}_{ji} - \overline{xy} ) ( {y}_{ji} - \overline{xy} )}{( n - 1 ) {{s}_{xy}}^{2}}$$
wherein j=1, 2, 3 . . . q, which represents a subscript of the subblock, xⱼᵢ and yⱼᵢ are elements in a jth subblock, x̅y̅ is a unite average of the jth subblock, and S_{xy}² is a unite variance of the jth subblock.

5. (canceled)

6. (canceled)

7. (canceled)

8. (canceled)

9. A data consistency check device based on an Intraclass Correlation Coefficient (ICC), comprising:
a memory configured to store computer programs; and
a processor configured to execute the computer programs so as to;
synchronously perform K-means clustering on source data X and backup data or recovery data Y, and determine respective class numbers and clustering center points;
determine whether the class numbers are the same and the clustering center points are the same, in a case where the class numbers are not the same and/or the clustering center points are not the same, return a result of inconsistency, and in a case where the class numbers are the same and the clustering center points are the same, continue to perform data comparison;
calculate a dimension N of classification results, and select a support vector or a complete basis, wherein any source data and any backup data or recovery data are able to be linearly represented by a support vector or a complete basis; and
calculate an ICC of each subblock, and in a case where the ICC is equal to 1, confirm data consistency and determine that data consistency check is completed.

10. A non-transitory computer-readable storage medium, configured to store computer programs, wherein
the computer programs are executed by a processor so as to implement following operations;
synchronously performing K-means clustering on source data X and backup data or recovery data Y, and determining respective class numbers and clustering center points;
determining whether the class numbers are the same and the clustering center points are the same, in a case where the class numbers are not the same and/or the clustering center points are not the same, returning a result of inconsistency, and in a case where the class numbers are the same and the clustering center points are the same, continuing to perform data comparison;
calculating a dimension N of classification results, and selecting a support vector or a complete basis, wherein any source data and any backup data or recovery data are able to be linearly represented by a support vector or a complete basis; and
calculating an ICC of each subblock, and in a case where the ICC is equal to 1, confirming data consistency and determining that data consistency check is completed.

11. The data consistency check method based on the ICC according to claim 3, wherein the PCA dimensionality reduction method comprises:
calculating a covariance matrix C=E[(X−E(X))(X−E(X))T] of n-dimension vectors {x1, x2, x3, . . . xk}; and
calculating eigenvalues and eigenvectors of the covariance matrix, arranging the eigenvectors from top to bottom in line according to the eigenvalues, forming a matrix P by front q lines, and determining P×X as data subjected to dimensionality reduction to a q-dimension.

12. The data consistency check method based on the ICC according to claim 1, wherein synchronously performing K-means clustering on source data X and backup data or recovery data Y comprises:
synchronously performing segmentation on the source data X and the backup data or recovery data Y based on a K-means clustering algorithm.

13. The data consistency check method based on the ICC according to claim 1, wherein determining respective class numbers and clustering center points comprises:
determining the class numbers of the source data X and the backup data or recovery data Y, and the clustering center points of the source data X and the backup data or recovery data Y.

14. The data consistency check method based on the ICC according to claim 2, wherein the source data X and the backup data or recovery data Y are respectively divided into K types to obtain the classification results {x1, x2, x3, . . . xk} and {y1, y2, y3, . . . yk}.

15. The data consistency check method based on the ICC according to claim 1, wherein selecting the support vector or the complete basis comprises:
selecting support vectors or complete bases {x1, x2, x3, . . . xk} and {y1, y2, y3, . . . yn} under K sets of data so that any source data x are able to be linearly represented by {x1, x2, x3, . . . xn}, and any backup data or recovery data y are able to be linearly represented by {y1, y2, y3, . . . yn}.

16. The data consistency check method based on the ICC according to claim 3, wherein calculating the ICC of each subblock comprises:
calculating the ICC of each subblock according to the dimensionality-reduced subblocks.

17. The data consistency check method based on the ICC according to claim 4, wherein unite variance is a square of a unite standard error.

18. The data consistency check method based on the ICC according to claim 1, wherein selecting the support vector or the complete basis comprises:
selecting a representative subblock to serve as the support vector or the complete basis.

19. The data consistency check device based on the ICC according to claim 9, wherein
the class numbers and the clustering center points are determined according to following formulas:
$${x}_{s s e} = {\sum }_{k = 1}^{K} {\sum }_{x ∈ {X}_{k}} {\vert x - {m}_{k} \vert}^{2}$$
$${y}_{s s e} = {\sum }_{k = 1}^{K} {\sum }_{y ∈ {Y}_{k}} {\vert y - {m}_{k} \vert}^{2}$$
when xₛₛₑ and yₛₛₑ are minimum, K is the class number, and mₖ is the clustering center point.

20. The data consistency check device based on the ICC according to claim 9, wherein a dimension of the support vector or the complete basis is subjected to dimensionality reduction processing through a Principal Component Analysis (PCA) dimensionality reduction method.

21. The data consistency check device based on the ICC according to claim 9, wherein a computational formula of the ICC is as below:
$${ICC}_{j} = \frac{{\sum }_{i = 1}^{n} ( {x}_{ji} - \overline{xy} ) ( {y}_{ji} - \overline{xy} )}{( n - 1 ) {{s}_{xy}}^{2}}$$
wherein j=1, 2, 3 . . . q, which represents a subscript of the subblock, xⱼᵢ and yⱼᵢ are elements in a jth subblock, x̅y̅ is a unite average of the jth subblock, and S_{xy}² is a unite variance of the jth subblock.

22. The data consistency check device based on the ICC according to claim 20, wherein the processor is configured to execute the computer programs so as to:
calculate a covariance matrix C=E[(X−E(X))(X−E(X))T] of n-dimension vectors {x1, x2, x3, . . . xk}; and
calculate eigenvalues and eigenvectors of the covariance matrix, arrange the eigenvectors from top to bottom in line according to the eigenvalues, form a matrix P by front q lines, and determine P×X as data subjected to dimensionality reduction to a q-dimension.

23. The data consistency check device based on the ICC according to claim 20, wherein the processor is configured to execute the computer programs so as to:
calculate the ICC of each subblock according to the dimensionality-reduced subblocks.

24. The data consistency check device based on the ICC according to claim 9, wherein the processor is configured to execute the computer programs so as to:
select a representative subblock to serve as the support vector or the complete basis.
